(19) United States
(12) Patent Application Publication
(10) Pub. No.: US 2025/0293817 A1
(43) Pub. Date: Sep. 18, 2025

(54) LINK TRAINING FOR BOOKENDED LINKS

(71) Applicant: MaxLinear, Inc., Carlsbad, CA (US)

(72) Inventor: Mario Milicevic, Irvine, CA (US)

(73) Assignee: MaxLinear, Inc., Carlsbad, CA (US)

(21) Appl. No.: 19/080,739

(22) Filed: Mar. 14, 2025

Related U.S. Application Data
(60) Provisional application No. 63/565,495, filed on Mar. 14, 2024.

(51) Int. Cl. H04L 1/20; H04L 1/00; H04L 7/02

(52) U.S. Cl. CPC H04L 1/203; H04L 1/0061; H04L 7/02

(57) ABSTRACT

A system may include a first link including a first digital signal processor (DSP), a first optical receiver, and a first optical transmitter. The system may include a second link including a second DSP, a second optical receiver, and a second optical transmitter. The second DSP may be coupled to the first DSP using one or more of an active electrical cable or an active optical cable. The second DSP may communicate with the first DSP using one or more forward error correction (FEC) padding bits or one or more reserved bits.

### RELATED APPLICATION

This application claims the benefit of U.S. Provisional Application No. 63/565,495, filed Mar. 14, 2024, the disclosure of which is incorporated herein by reference in its entirety for all purposes.

The examples discussed in the present disclosure are related to link training and associated methods.

### BACKGROUND

Unless otherwise indicated herein, the materials described herein are not prior art to the claims in the present application and are not admitted to be prior art by inclusion in this section.

A digital signal processor (DSP) may be used to measure, filter, or compress analog signals. DSPs may be used for digital signal processing algorithms. Many DSP applications may have constraints on latency. Systems, methods, and devices for enhancing the performance of DSPs may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A system may include a first link including a first digital signal processor (DSP), a first optical receiver, and a first optical transmitter. The system may include a second link including a second DSP, a second optical receiver, and a second optical transmitter. The second DSP may be coupled to the first DSP using one or more of an active electrical cable or an active optical cable. The second DSP may communicate with the first DSP using one or more forward error correction (FEC) padding bits or one or more reserved bits.

A method for link training may include sending, at a first optical transmitter coupled to a first digital signal processor (DSP), a first signal to a second optical receiver coupled to a second digital signal processor. The method may include computing, at the second DSP, one or more signal parameters of the first signal. The method may include generating, at the second DSP, a second signal comprising one or more FEC padding bits or one or more reserved bits including the one or more signal parameters. The method may include sending, using a second optical transmitter coupled to the second DSP, the second signal to a first optical receiver coupled to the first DSP.

A device may include a first DSP. The first DSP may send, from a first optical transmitter coupled to the first DSP, a first signal for transmission to a second optical receiver coupled to a second digital signal processor. The first DSP may receive, at a first optical receiver coupled to the first DSP, a second signal comprising one or more FEC padding bits or one or more reserved bits. The one or more FEC padding bits or the one or more reserved bits may include one or more signal parameters of the first signal. The first DSP may compute, at the first DSP, one or more additional signal parameters of a third signal based on the one or more signal parameters of the first signal. The first DSP may send, from the first optical transmitter coupled to the first DSP, the third signal for transmission to the second optical receiver coupled to the second digital signal processor.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of a system for link training.

FIG. 2A illustrates an example of a device for link training.

FIG. 2B illustrates an example of a device for link training.

FIG. 3 illustrates an example process flow for link training.

FIG. 4 illustrates an example process flow for link training.

FIG. 5 illustrates a block diagram of an example system for link training.

FIG. 6 illustrates a diagrammatic representation of a machine in the example form of a computing device within which a set of instructions, for causing the machine to perform any one or more of the methods discussed herein, may be executed.

### DESCRIPTION

Different links may be coupled using active electrical cables or active optical cables. The links may be bookended (i.e., one on the left and one on the right) and the links may be mirror images of one another. When a link is bookended in this manner, a digital signal processor (DSP) on one of the links may be the same vendor as the DSP on the mirror image link. Communicating from a DSP in a link to another DSP in a mirror image link may facilitate the communication of one or more signal parameters that may be used in one or more of power adjustment, digital pre-distortion calibration, bit error rate testing, and/or time synchronization. In some examples, the link may not be exact mirrors, but may be similar and have similar components.

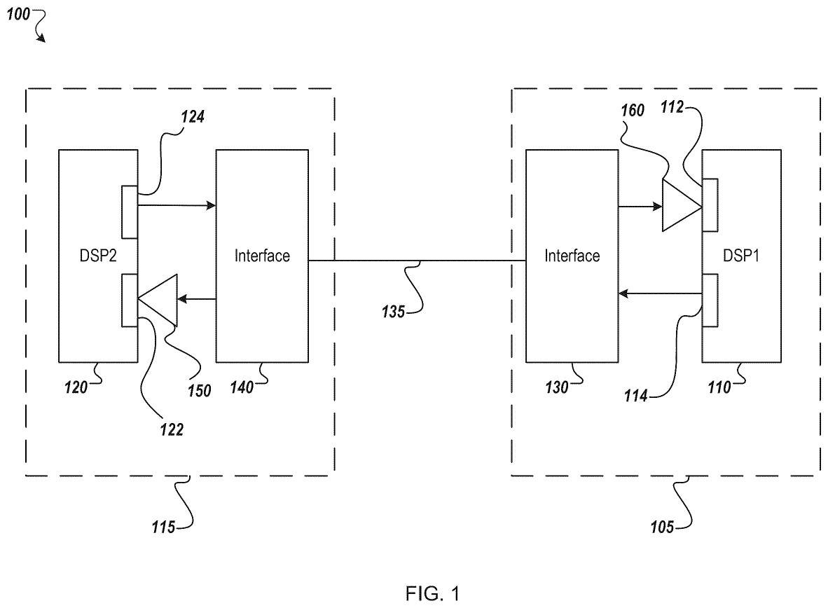

As illustrated in FIG. 1, a system 100 may include a first link 105 and a second link 115. The first link 105 may include a first DSP 110, a first optical receiver 112, and a first optical transmitter 114. The first DSP 110 may be coupled to one or more of the first optical receiver 112 and/or the first optical transmitter 114. For purposes of this disclosure, coupled may mean directly coupled or indirectly coupled.

The system 100 may include a second link 115 including a second DSP 120, a second optical receiver 122, and a second optical transmitter 124. The second DSP 120 may be coupled to the first DSP 110 using one or more of an active electrical cable (e.g., a copper wire) or an active optical cable (e.g., fiber).

The second link may be a mirrored link of the first link. In one example, the first link 105 may include a DSP1 110 that may be a variant of DSP2 120. In another example, the first link 105 may include a trans-impedance amplifier (TIA) 160 that may be a variant of a TIA 150 at the second link 115. In another example, the first link may include a first optical receiver 112 and first optical transmitter 114 that may be a variant of the second optical receiver 122 and the second optical transmitter 124.

The first DSP 110 may receive first trans-impedance amplifier (TIA) output from a first TIA 160 and the second DSP 120 may receive second TIA output from a second TIA 150. The first link 105 may be coupled to the second link 115 using a connection 135 between an interface 130 and an interface 140. The connection 135 between the interface 130 and the interface 140 may be an active electrical connection (AEC) or an active optical connection (AOC). When the connection 135 is an AOC, the interface 130 and the interface 140 may be an optical interface and the connection 135 may be an optical connection such as a fiber connection. When the connection 135 is an AEC, the interface 130 and the interface 140 may be an electrical connection and the connection 135 may be an electrical connection such as a copper wire.

The second DSP 120 may communicate with the first DSP 110 using one or more forward error correction (FEC) padding bits. The FEC padding bits may be inner FEC padding bits. The FEC padding bits may be used for link training.

In addition or alternatively, the second DSP 120 may communicate with the first DSP 110 using one or more reserved bits. The one or more reserved bits may be defined by a proprietary protocol. The reserved bits may be used for link training.

For example, a first optical transmitter (OTX1) 114 may transmit using a particular power level. OTX1 114 may communicate a signal to a second optical receiver (ORX2) 122. A second optical transmitter (OTX2) 124 may transmit a signal to the first optical receiver (ORX1) 112. The signal communicated from OTX2 124 to ORX1 112 may include information about the power level for OTX1 114. DSP1 110 may vary the power level of OTX1 114 based on the information about the power level for OTX1 114. The first digital signal processor 110 may adjust a first power level of the first optical transmitter OTX1 114 based on a second power level of the second optical receiver ORX2 122 using the one or more FEC padding bits or the one or more reserved bits. The one or more FEC padding bits or reserved bits may be used to facilitate communication between DSP2 120 and DSP1 110.

When the power is too high, as detected at ORX2 122, the power may be reduced at OTX1 114. A signal from OTX2 124 to ORX1 112 may inform DSP1 that the power level received at ORX2 122 is too high. This signal from OTX2 124 to ORX1 112 may include information about the power level received at ORX2 122 in one or more FEC padding bits (e.g., inner FEC padding bits) or one or more reserved bits. Power may be saved in this end to end system by detecting the power level at ORX2 122 and reducing the power level at OTX1 114.

In another example, the first DSP (e.g., DSP1 110) may calibrate its transmitter or digital pre-distortion (DPD) engine using the one or more FEC padding bits or the one or more reserved bits received from the second link 115 (e.g., via OTX2 124). A signal from OTX1 114 may be sensed at ORX2 122. The signal may be used to generate a received waveform in memory in DSP2 120. Bits from the waveform in memory in DSP2 120 may be written to one or more FEC padding bits or one or more reserved bits and sent via OTX2 124 to ORX1 112 where the bits may be used to capture the waveform on DSP1. DSP1 may then recalibrate its transmitter (e.g., analog circuits) or digital pre-distortion engine (e.g., using firmware).

In another example, the first DSP 110 may perform a bit error rate test using the one or more FEC padding bits or the one or more reserved bits received from the second link 115. A pseudo random binary sequence (PRBS) may be inserted into the one or more FEC padding bits or reserved bits to be transmitted using OTX1 114 to be received at ORX2 122. The bits received at ORX2 122 may be checked based on an expected pseudorandom binary sequence (PRBS) to facilitate a bit error rate test using DSP2 120. If a bit is incorrect, a bit error may be flagged by DSP2 120.

In another example, the first DSP 110 may perform time synchronization using the one or more FEC padding bits or the one or more reserved bits received from the second link 115. For example, a time stamp may be sent from OTX1 114 to ORX2 122. DSP2 may generate a time stamped signal in which the time stamp may be communicated using the one or more FEC padding bits (e.g., the inner FEC padding bits) or the one or more reserved bits. DSP1 110 may receive the one or more FEC padding bits or the one or more reserved bits via ORX1 112. DSP1 110 may extract a time stamp using the one or more FEC padding bits or the one or more reserved bits. DSP1 110 may perform time synchronization using the time stamp.

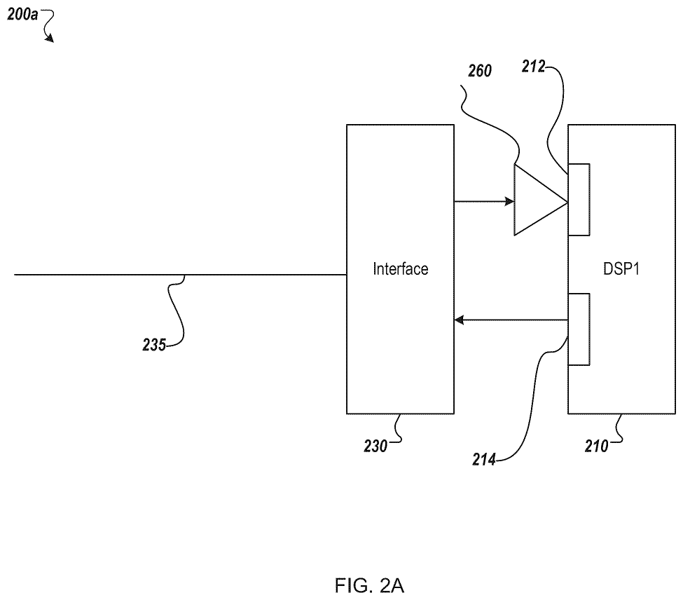

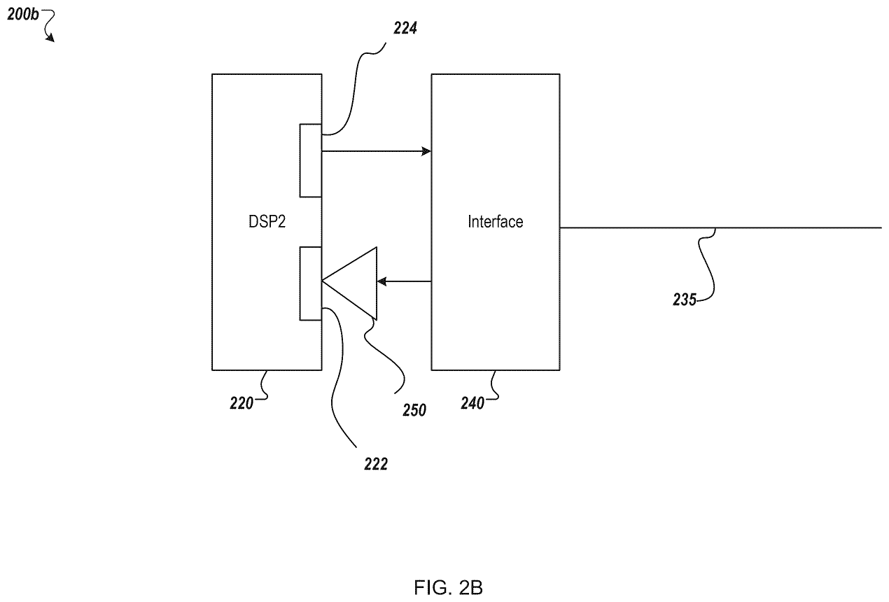

As illustrated in FIG. 2A, a device 200a may include a first DSP 210 that may send, from a first optical transmitter 214 coupled to the first DSP 210, a first signal for transmission to a second optical receiver coupled to a second digital signal processor via the connection 235 (which may be an AOC or AEC). The first DSP 210 may receive, at a first optical receiver 212 coupled to the first DSP 210, a second signal comprising one or more FEC padding bits or one or more reserved bits including one or more signal parameters of the first signal. The first DSP 210 may compute, at the first DSP 210, one or more additional signal parameters of a third signal based on the one or more signal parameters of the first signal. The DSP 210 may send, from the first optical transmitter 214 coupled to the first DSP 210, the third signal for transmission to the second optical receiver coupled to the second digital signal processor (e.g., via the interface 230 and the connection 235).

The first digital signal processor may perform one or more of: (a) adjust a power level of the third signal based on the one or more signal parameters of the first signal; (b) calibrate one or more of a transmitter or a digital pre-distortion (DPD) engine using the one or more FEC padding bits or the one or more reserved bits; (c) perform a bit error rate test using the one or more FEC padding bits or the one or more reserved bits; or (d) perform time synchronization using the one or more FEC padding bits or the one or more reserved bits. The first digital signal processor 210 may receive, at the first optical receiver 212 coupled to the first DSP 210, first TIA output from a first TIA 260.

As illustrated in FIG. 2B, a device 200b may include a second DSP 220 that may receive, at a second optical receiver 222 coupled to the second DSP 220 from a first optical transmitter coupled to the first DSP, a first signal via the connection 235 (which may be an AOC or AEC). The second DSP 220 may send, at a second optical transmitter 224 to a first optical receiver coupled to the first DSP, a second signal comprising one or more FEC padding bits or one or more reserved bits including one or more signal parameters of the first signal. The second DSP 220 may receive, at the second optical receiver 222 coupled to the second DSP 220 from the first optical transmitter coupled to the first DSP, the third signal via the connection 235 and the interface 240. The second digital signal processor 220 may receive, at the second optical receiver 222 coupled to the second DSP 220, second TIA output from a second TIA 250.

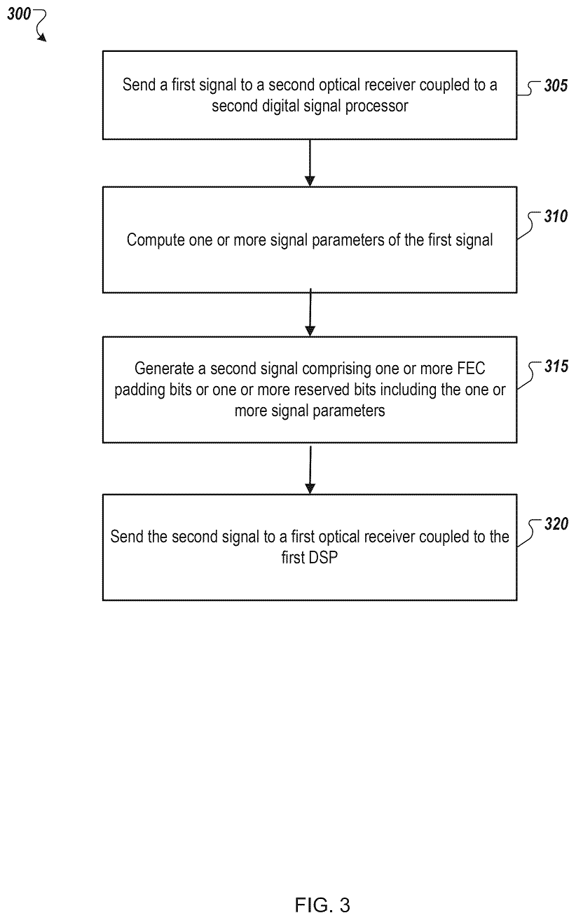

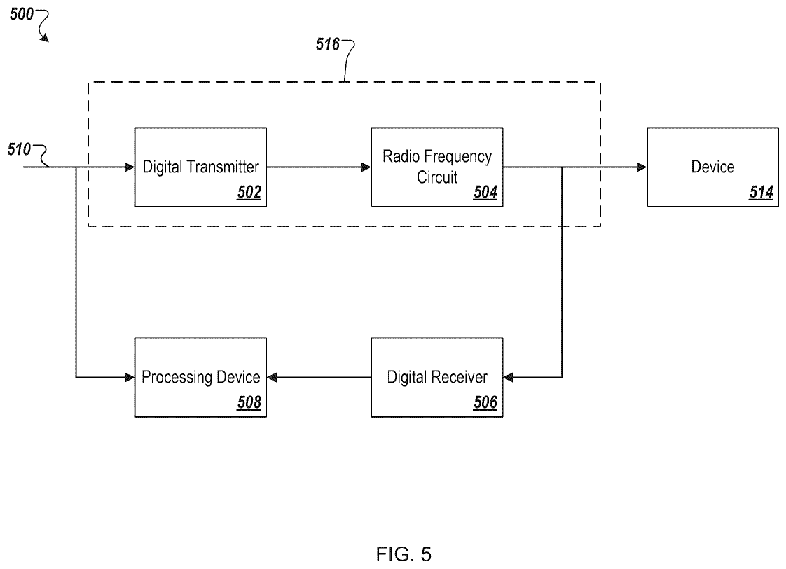

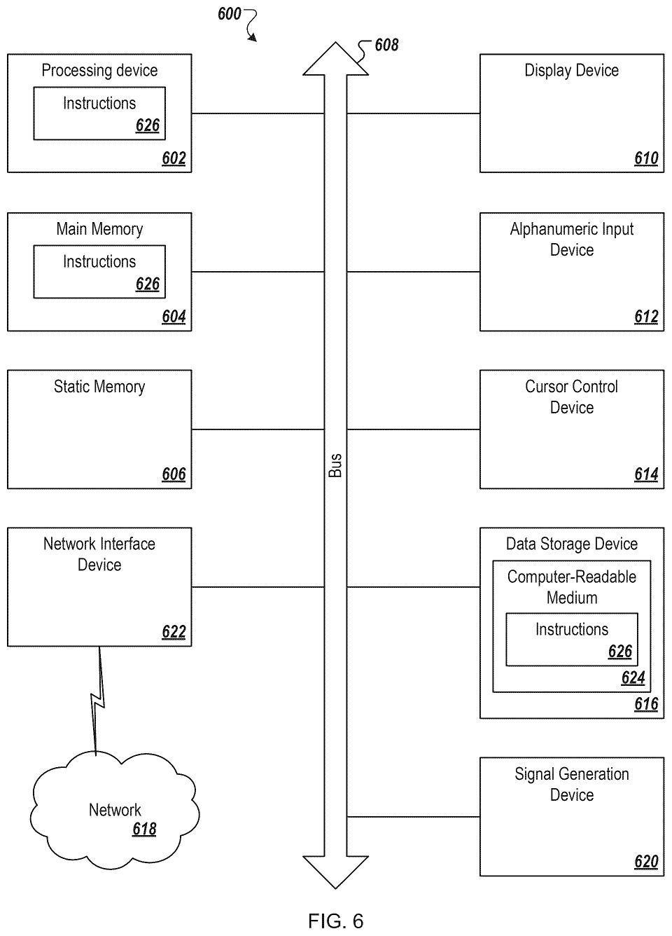

FIG. 3 illustrates a process flow of an example method 300 of link training, in accordance with at least one example described in the present disclosure. The method 300 may be arranged in accordance with at least one example described in the present disclosure. The method 300 may be performed by processing logic that may include hardware (circuitry, dedicated logic, etc.), software (such as is run on a computer system or a dedicated machine), or a combination of both, which processing logic may be included in the processor (e.g., the processing device 602 of FIG. 6), the communication system 500 of FIG. 5, or another device, combination of devices, or systems.

The method 300 may begin at block 305 where the processing logic may send, at a first optical transmitter coupled to a first digital signal processor (DSP), a first signal to a second optical receiver coupled to a second digital signal processor. At block 310, the processing logic may compute, at the second DSP, one or more signal parameters of the first signal. At block 315, the processing logic may generate, at the second DSP, a second signal comprising one or more FEC padding bits or one or more reserved bits including the one or more signal parameters. At block 320, the processing logic may send, using a second optical transmitter coupled to the second DSP, the second signal to a first optical receiver coupled to the first DSP.

The processing logic may adjust, at the first optical transmitter coupled to the first DSP, a first optical transmitter power level based on the one or more signal parameters. The processing logic may calibrate, at the first DSP, one or more of a transmitter or a digital pre-distortion (DPD) engine based on the one or more signal parameters. The processing logic may perform, at the first DSP, a bit error rate test based on the one or more signal parameters. The processing logic may synchronize, at the first DSP, the first DSP with the second DSP using the one or more signal parameters.

The first DSP may receive first trans-impedance amplifier (TIA) output from a first TIA. The second DSP may receive second TIA output from a second trans-impedance amplifier (TIA).

Modifications, additions, or omissions may be made to the method 300 without departing from the scope of the present disclosure. For example, in some examples, the method 300 may include any number of other components that may not be explicitly illustrated or described.

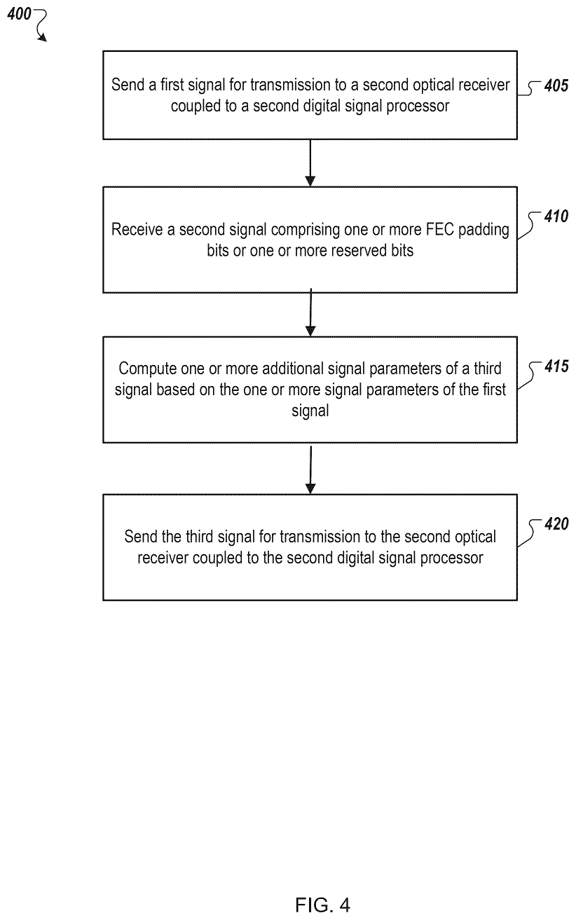

FIG. 4 illustrates a process flow of an example method 400 of link training, in accordance with at least one example described in the present disclosure. The method 400 may be arranged in accordance with at least one example described in the present disclosure. The method 400 may be performed by processing logic that may include hardware (circuitry, dedicated logic, etc.), software (such as is run on a computer system or a dedicated machine), or a combination of both, which processing logic may be included in the processor (e.g., the processing device 602 of FIG. 6), the communication system 500 of FIG. 5, or another device, combination of devices, or systems.

The method 400 may begin at block 405 where the processing logic may send, from a first optical transmitter coupled to the first DSP, a first signal for transmission to a second optical receiver coupled to a second digital signal processor. At block 410, the processing logic may receive, at a first optical receiver coupled to the first DSP, a second signal comprising one or more FEC padding bits or one or more reserved bits, wherein the one or more FEC padding bits or the one or more reserved bits include one or more signal parameters of the first signal. At block 415, the processing logic may compute, at the first DSP, one or more additional signal parameters of a third signal based on the one or more signal parameters of the first signal. At block 420, the processing logic may send, from the first optical transmitter coupled to the first DSP, the third signal for transmission to the second optical receiver coupled to the second digital signal processor.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500 configured for link training, in accordance with at least one example described in the present disclosure. The communication system 500 may include a digital transmitter 502, a radio frequency circuit 504, a device 514, a digital receiver 506, and a processing device 508. The digital receiver 506 and the processing device may be configured to receive a baseband signal via connection 510. A transceiver 516 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 516 may be communicatively coupled to the device 514.

In some examples, the transceiver 516 may be configured to obtain a baseband signal. For example, as described herein, the transceiver 516 may be configured to generate a baseband signal and/or receive a baseband signal from another device. In some examples, the transceiver 516 may be configured to transmit the baseband signal. For example, upon obtaining the baseband signal, the transceiver 516 may be configured to transmit the baseband signal to a separate device, such as the device 514. Alternatively, or additionally, the transceiver 516 may be configured to modify, condition, and/or transform the baseband signal in advance of transmitting the baseband signal. For example, the transceiver 516 may include a quadrature up-converter and/or a digital to analog converter (DAC) that may be configured to modify the baseband signal. Alternatively, or additionally, the transceiver 516 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 516 may include one or more subcomponents that may be used in preparing the baseband signal and/or transmitting the baseband signal. For example, the transceiver 516 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 516 may be synchronized with the resource controller via the S-plane device, which may contribute to high-accuracy timing with respect to a reference clock.

In some examples, the transceiver 516 may be configured to obtain the baseband signal for transmission. For example, the transceiver 516 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 516 may be configured to generate a baseband signal for transmission. In these and other examples, the transceiver 516 may be configured to transmit the baseband signal to another device, such as the device 514.

In some examples, the transceiver 516 may be configured to receive a transmission from the device 514. In some examples, the transceiver 516 may be configured to transmit a baseband signal to the device 514.

In some examples, the radio frequency circuit 504 may be configured to transmit the digital signal received from the digital transmitter 502. In some examples, the radio frequency circuit 504 may be configured to transmit the digital signal to the device 514 and/or the digital receiver 506. In some examples, the digital receiver 518 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 516. In instances in which the processing device 508 is a standalone device or system, the processing device 508 may be configured to communicate with additional devices and/or systems remote from the processing device 508, such as the transceiver 516 and/or the device 514. For example, the processing device 508 may be configured to send and/or receive transmissions from the transceiver 516 and/or the device 514. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A system comprising:
a first link comprising a first digital signal processor (DSP), a first optical receiver, and a first optical transmitter; and
a second link comprising a second DSP, a second optical receiver, and a second optical transmitter, wherein the second DSP is coupled to the first DSP using one or more of an active electrical cable or an active optical cable,
wherein the second DSP is operable to communicate with the first DSP using one or more forward error correction (FEC) padding bits or one or more reserved bits.

2. The system of claim 1, wherein the second link is a mirrored link of the first link.

3. The system of claim 1, wherein the first digital signal processor is operable to adjust a first power level of the first optical transmitter based on a second power level of the second optical receiver by using the one or more FEC padding bits or the one or more reserved bits.

4. The system of claim 1, wherein the first DSP is operable to calibrate one or more of a transmitter or a digital pre-distortion (DPD) engine using the one or more FEC padding bits or the one or more reserved bits received from the second link.

5. The system of claim 1, wherein the first DSP is operable to perform a bit error rate test using the one or more FEC padding bits or the one or more reserved bits received from the second link.

6. The system of claim 1, wherein the first DSP is operable to perform time synchronization using the one or more FEC padding bits or the one or more reserved bits received from the second link.

7. The system of claim 1, wherein the first DSP is operable to receive first trans-impedance amplifier (TIA) output from a first TIA and the second DSP is operable to receive second TIA output from a second TIA.

8. A method for link training, comprising:
sending, at a first optical transmitter coupled to a first digital signal processor (DSP), a first signal to a second optical receiver coupled to a second digital signal processor;
computing, at the second DSP, one or more signal parameters of the first signal;
generating, at the second DSP, a second signal comprising one or more FEC padding bits or one or more reserved bits including the one or more signal parameters; and
sending, using a second optical transmitter coupled to the second DSP, the second signal to a first optical receiver coupled to the first DSP.

9. The method of claim 8, further comprising:
adjusting, at the first optical transmitter coupled to the first DSP, a first optical transmitter power level based on the one or more signal parameters.

10. The method of claim 8, further comprising:
calibrating, at the first DSP, one or more of a transmitter or a digital pre-distortion (DPD) engine based on the one or more signal parameters.

11. The method of claim 8, further comprising:
performing, at the first DSP, a bit error rate test based on the one or more signal parameters.

12. The method of claim 8, further comprising:
synchronizing, at the first DSP, the first DSP with the second DSP using the one or more signal parameters.

13. The method of claim 8 further comprising:
receiving, at the first DSP, first trans-impedance amplifier (TIA) output from a first TIA.

14. The method of claim 8, further comprising:
receiving, at the second DSP, second TIA output from a second trans-impedance amplifier (TIA).

15. A device, comprising:
a first digital signal processor (DSP) operable to:
send, from a first optical transmitter coupled to the first DSP, a first signal for transmission to a second optical receiver coupled to a second digital signal processor;
receive, at a first optical receiver coupled to the first DSP, a second signal comprising one or more FEC padding bits or one or more reserved bits, wherein the one or more FEC padding bits or the one or more reserved bits include one or more signal parameters of the first signal;
compute, at the first DSP, one or more additional signal parameters of a third signal based on the one or more signal parameters of the first signal; and
send, from the first optical transmitter coupled to the first DSP, the third signal for transmission to the second optical receiver coupled to the second digital signal processor.

16. The device of claim 15, wherein the first digital signal processor is operable to adjust a power level of the third signal based on the one or more signal parameters of the first signal.

17. The device of claim 15, wherein the first digital signal processor is operable to calibrate one or more of a transmitter or a digital pre-distortion (DPD) engine using the one or more FEC padding bits or the one or more reserved bits.

18. The device of claim 15, wherein the first digital signal processor is operable to perform a bit error rate test using the one or more FEC padding bits or the one or more reserved bits.

19. The device of claim 15, wherein the first digital signal processor is operable to perform time synchronization using the one or more FEC padding bits or the one or more reserved bits.

20. The device of claim 15, wherein the first digital signal processor is operable to receive, at the first optical receiver coupled to the first DSP, first trans-impedance amplifier (TIA) output from a first TIA.
